(19) United States
(12) Patent Application Publication
(10) Pub. No.: US 2013/0178591 A1
(43) Pub. Date: Jul. 11, 2013

(54) ADVANCED POLY EPOXY ESTER RESIN COMPOSITIONS

(71) Applicants: Xin Jin, Lake Jackson, TX (US); Ray E. Drumright, Midland, MI (US); Bernhard Kainz, Lauf (DE); Jerry E. White, Lake Jackson, TX (US); Robert E. Hefner, JR., Rosharon, TX (US)

(72) Inventors: Xin Jin, Lake Jackson, TX (US); Ray E. Drumright, Midland, MI (US); Bernhard Kainz, Lauf (DE); Jerry E. White, Lake Jackson, TX (US); Robert E. Hefner, JR., Rosharon, TX (US)

(73) Assignee: Dow Global Technologies LLC, Midland, MI (US)

(21) Appl. No.: 13/814,807

(22) PCT Filed: Sep. 22, 2011
(86) PCT No.: PCT/US2011/052672

§ 371 Date: Feb. 7, 2013

Related U.S. Application Data
(60) Provisional application No. 61/388,072, filed on Sep. 30, 2010.

(51) Int. Cl. C08G 63/672

(52) U.S. Cl. CPC C08G 63/672
USPC 525/437; 528/298

(57) ABSTRACT

A poly epoxy ester resin composition of the following chemical structure: where n is a number from 2 to about 3000; each m independently has a value of 0 or 1; each R⁰ is independently —H or —CH₃; each R¹ is independently —H or a C₁ to C₆ alkylene radical (saturated divalent aliphatic hydrocarbon radical), Ar is a divalent aryl group or heteroarylene group;_and X is cycloalkylene group, including substituted cycloalkylene group, where the substitute group include an alkyl, cycloalkyl, an aryl or an aralkyl group or other substitute group, for example, a halogen, a nitro, a blocked isocyanate, or an alkyloxy group; the combination of cycloalkylene and alkylene groups and the combination of alkylene and cycloalkylene group with a bridging moiety in between.

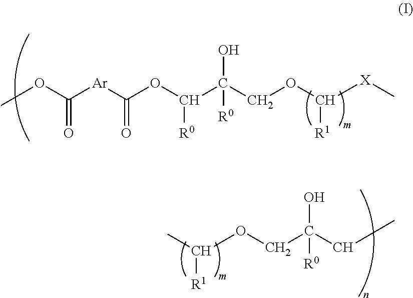

This application is a non-provisional application claiming priority from the U.S. Provisional Patent Application No. 61/388,072, filed on Sep. 30, 2010, entitled “ADVANCED POLY EPDXY ESTER RESIN COMPOSITIONS” the teachings of which are incorporated by reference herein, as if reproduced in full hereinbelow.

### BACKGROUND OF THE INVENTION

1. Field of the Invention

The present invention relates to an advanced poly epoxy ester resin composition prepared from a reaction mixture comprising a cycloaliphatic diglycidyl ether compound produced as a result of an epoxidation reaction. The advanced poly epoxy ester resin composition of the present invention has been found to be useful in coatings applications; particularly for internal or external protective coatings for cans and other metal packaging coatings.

2. Description of Background and Related Art

Epoxy resins are well-known polymers with diverse applications such as metal can coatings, general metal, and marine protective coatings, automotive primer, printed circuit boards, semiconductor encapsulants, adhesives, and aerospace composites. High molecular weight epoxy resins based on bisphenol A are widely used in the coatings industry. High molecular weight epoxy resins can be cured through the terminal epoxy groups and the multiple hydroxyl groups along the backbones to provide good mechanical properties and performance. However, the bisphenol A based high molecular weight solid epoxy resins have limited flexibility and toughness at room temperature. The toughness deficiency is an issue in certain applications. Significant efforts have been devoted to improve toughness and flexibility of epoxy resins. For example, J. M. Dean et al reported in J. Polym. Sci., Part B: Polym. Phys. 39, 2996, 3010 (2001) that incorporation of block copolymers has been shown to improve toughness of certain epoxy systems. S. R. White et al in Nature 409, 794, 797 (2001) reported that nanocomposites and self-healing epoxy systems represent new approaches to develop tougher epoxies.

WO2009/142901, incorporated herein by reference, describes an epoxy resin composition comprising a product mixture and isolation of high purity DGE therefrom.

WO2009/142901 also describes a process for preparing the above epoxy resin product mixture, by reacting (1) a mixture of a cis-1,3-cyclohexanedimethanol, a trans-1,3-cyclohexanedimethanol, a cis-1,4-cyclohexanedimethanol, and a trans-1,4-cyclohexanedimethanol, (2) an epihalohydrin, (3) a basic acting substance, (4) optionally, a solvent, (5) optionally, a catalyst, and (6) optionally, a dehydrating agent.

WO2009/142901 also describes preparing a high purity (>99.0 area %) cyclohexanedimethanol diglycidyl ether that is free of oligomeric components by vacuum distillation. In the process of WO2009/142901, after distillation, the desired high purity cyclohexanedimethanol diglycidyl ether product is separated from the pot residue and available to be used in a subsequent process. A high purity cyclohexanedimethanol diglycidyl ether monomer is used to prepare a substantially linear high molecular weight poly epoxy ester resin because any reactive impurities in the monomers can affect the molecular weight and chain architecture of the resulting reaction product of cyclohexanedimethanol diglycidyl ether. The principle of molecular weight control in linear step polymerization is discussed, for example, by George Odian in Principles of Polymerization, 4^{th} edition, incorporated herein by reference.

It is desired to provide a high molecular weight poly epoxy ester resin that comprises a polymerization product of at least one cycloaliphatic diglycidyl ether compound, including cyclohexanedimethanol diglycidyl ether, and shows high elongation at break and high tensile toughness.

### SUMMARY OF THE INVENTION

The present invention provides a solution to the problem of the skilled artisan's inability to manufacture a high molecular weight poly epoxy ester resin based on cycloaliphatic diglycidyl ethers wherein the poly epoxy ester resin has adequate flexibility for handling and using such resins. For example, the present invention provides high molecular weight poly epoxy ester resins with a high level of elongation at break and high tensile toughness, which in turn, provides coatings made from such resins with improved coating performance in the case of coating deformation during and after a coating process.

One embodiment of the present invention is directed to a poly epoxy ester resin composition comprising a polymeric composition having the following chemical structure, Structure (I):

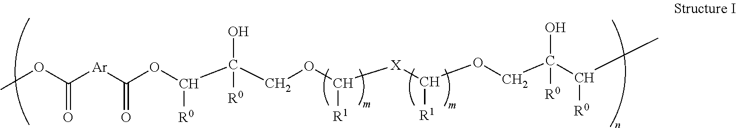

where n is a number from 1 to about 3000; each m independently has a value of 0 or 1; each R⁰ is independently —H or —CH₃; each R¹ is independently —H or a C₁ to C₆ alkylene radical (saturated divalent aliphatic hydrocarbon radical), Ar is a divalent aryl group or heteroarylene group; and X is cycloalkylene group, including substituted cycloalkylene group, where the substitute group include an alkyl, cycloalkyl, an aryl or an aralkyl group or other substitute group, for example, a halogen, a nitro, a blocked isocyanate, or an alkyloxy group; the combination of cycloalkylene and alkylene groups and the combination of alkylene and cycloalkylene group with a bridging moiety in between.

Another embodiment of the present invention is directed to high molecular weight poly epoxy ester resin composition including the reaction product of (a) at least one cycloaliphatic diglycidyl ether compound, for example, a product mixture comprising 1,3 and 1,4 cis and trans cyclohexanedimethanol diglycidyl ether formed during an epoxidation process, and (b) at least one aromatic dicarboxylic acid compound.

One preferred example of a cycloaliphatic diglycidyl ether useful in the present invention to build novel high molecular weight poly epoxy ester resins is UNOXOL™ Diol DGE, which is a product mixture comprising a diglycidyl ether of cis-1,3-cyclohexanedimethanol, a diglycidyl ether of trans-1,3-cyclohexanedimethanol, a diglycidyl ether of cis-1,4-cyclohexanedimethanol, and a diglycidyl ether of trans-1,4-cyclohexanedimethanol. [UNOXOL™ cyclic dialcohol is a registered trademark of Union Carbide Corporation.] WO2009/142901 describes an epoxy resin composition comprising such a product mixture and isolation of high purity diglycidyl ether (DGE) therefrom.

Another preferred example of a cycloaliphatic diglycidyl ether useful in the present invention to build new high molecular weight poly epoxy ester resins comprises a diglycidyl ether of cis-1,4-cyclohexanedimethanol, a diglycidyl ether of trans-1,4-cyclohexanedimethanol, and a product mixture thereof.

The high molecular weight poly epoxy ester resin compositions of the present invention have unusually high flexibility and high toughness at room temperature. The material flexibility and toughness were characterized by stress-strain behavior of the polymeric resin. Elongation to break is a common parameter to measure flexibility and tensile toughness, fundamental mechanical properties of materials. The tensile toughness is a measure of the ability of a material to absorb energy in a tensile deformation. The elongations to break of the poly epoxy ester resins of the present invention are over about 100 to over about 1000 times higher than a typical prior known 9-type bisphenol A based advanced epoxy resin. In addition, the tensile toughnesses of the poly epoxy ester resins of the present invention are over about 100 times stronger than a typical prior known 9-type bisphenol A based advanced epoxy resin.

Another embodiment of the present invention is directed to a curable high molecular weight poly epoxy ester resin composition comprising (i) the above advanced poly epoxy ester resin of Structure (I); (ii) a curing agent; (iii) at least one curing catalyst; (iv) optionally, at least one solvent and (v) optionally, at least one additive.

Still another embodiment of the present invention is directed to a cured thermoset resin prepared by curing the above curable advanced poly epoxy ester resin composition.

Polyesters known in the prior art offer flexibility but fail chemical and hydrolytic resistance; acrylic resins have the chemical and hydrolytic resistance but fail on flexibility; laminates of aromatic polyesters such as polyethylene terephthalate (PET) provide flexibility and resistance but suffer from issues with adhesion and cost; organosols provide flexibility at higher cost, however contain high levels chlorine bound to the resin.

The cured advanced poly epoxy ester resin composition of the present invention may be advantageously used for preparing coatings. For example, the present invention provides a composition and method for preparing a coating composition having unusually high flexibility and good organic solvent resistance and useful for metal packaging applications. The flexibility of the cured advanced high molecular weight poly epoxy ester resin composition was demonstrated by Wedge Bend Flexibility measurements and the solvent resistance was characterized by Methyl Ethyl Ketone (MEK) Double Rubs Test. The Wedge Bend Flexibility results indicate that the cured high molecular weight poly epoxy ester resin of the present invention are more flexible than the commonly known cured bisphenol A based high molecular weight 9-type epoxy resins. In addition, MEK Double Rub Test results illustrate that the cured high molecular weight poly epoxy ester resins of the present invention exhibit similar chemical solvent resistance when compared to a cured bisphenol A based high molecular weight epoxy resin.

### DETAILED DESCRIPTION OF THE INVENTION

In one broad embodiment, the high molecular weight poly epoxy ester resin of the present invention includes a novel advanced poly epoxy ester resin composition comprising a polymerization product from (a) a cycloaliphatic diglycidyl ether compound, such as a mixture of 1,3- and 1,4-cis- and trans-cyclohexanedimethanol diglycidyl ethers formed during an epoxidation process, and (b) at least one aromatic dicarboxylic acid compound.

By “high molecular weight” with reference to a poly epoxy ester resin it is meant that the poly epoxy ester resin's weight average molecular weight may be generally above about 300 and typically may be above about 1000. In other embodiments, the molecular weight may be above about 2000, preferably above about 3000, more preferably above about 4000, even more preferably above about 5000 and most preferably above about 7000.

One preferred broad embodiment of the present invention comprises an advanced poly epoxy ester resin having the following chemical Structure (I):

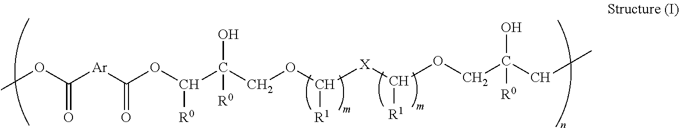

where n is a number from 1 to about 3000; each m independently has a value of 0 or 1; each R⁰ is independently —H or —CH₃; each R¹ is independently —H or a C₁ to C₆ alkylene radical (saturated divalent aliphatic hydrocarbon radical), Ar is a divalent aryl group or heteroarylene group; and X is cycloalkylene group, including substituted cycloalkylene group, where the substituent group include an alkyl, cycloalkyl, an aryl or an aralkyl group or other substituent group, for example, a halogen, a nitro, a blocked isocyanate, or an alkyloxy group; the combination of cycloalkylene and alkylene groups and the combination of alkylene and cycloalkylene group with a bridging moiety in between.

In another embodiment, the average number of repeating units, n, shown in above Structure (I), is generally a number from about 2 to about 1500, preferably a number from about 4 to about 1000, more preferably a number from about 6 to about 500, even more preferably a number from about 8 to about 100, and most preferably a number from about 10 to about 50.

As an illustration of one embodiment of the present invention, the preparation of the above advanced high molecular weight poly epoxy ester resin may be illustrated by the following reaction Scheme (I):

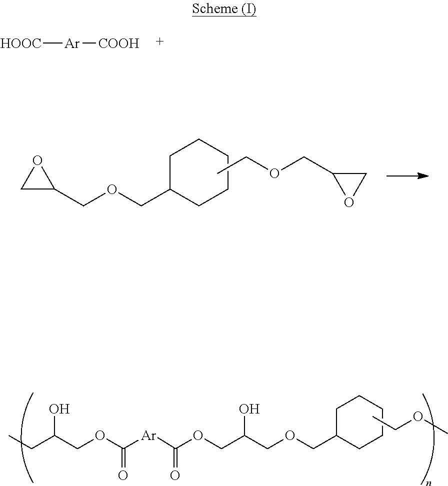

where Ar is a divalent aryl group or heteroarylene group; and the diepoxide compound may be, for example as shown above, a mixture comprising 1,3- and 1,4-cis- and trans-cyclohexanaedimethanol diglycidyl ethers (UNOXOL™ Diol diglycidyl ether (DGE)), which formed during an epoxidation process. Although the advanced poly epoxy ester resin illustrated above is a linear chain without branching, it is possible that small amounts of side-reactions may generate branching and primary hydroxyl groups along the polymer chains. The substantially linear advanced poly epoxy ester resin is soluble in suitable solvents without apparent gel particles.

Poly epoxy ester resins of the present invention can be made from the direct polymerization between aromatic dicarboxylic acids, such as isophthalic acid and 2,6-naphthalenedicarboxylic acid, and cylcoaliphatic diepoxide compounds. Furthermore, the poly epoxy ester resins of the present invention can be made from the polymerization of monomers comprising cyclohexanedimethanol diglycidyl ethers and aromatic dicarboxylic acid.

As aforementioned, one preferred example of cycloaliphatic diglycidyl ether of the present invention used to build the high molecular weight poly epoxy ester resins of the present invention is UNOXOL™ Diol DGE, which is a product mixture comprising a diglycidyl ether of cis-1,3-cyclohexanedimethanol, a diglycidyl ether of trans-1,3-cyclohexanedimethanol, a diglycidyl ether of cis-1,4-cyclohexanedimethanol, and a diglycidyl ether of trans-1,4-cyclohexanedimethanol. WO2009/142901 describes an epoxy resin composition comprising such a product mixture and the isolation of a high purity DGE therefrom.

Another preferred example of cycloaliphatic diglycidyl ether used to build new high molecular weight poly epoxy ester resins in this invention comprises a diglycidyl ether of cis-1,4-cyclohexanedimethanol, a diglycidyl ether of trans-1,4-cyclohexanedimethanol, and a product mixture thereof.

Other examples of cycloaliphatic diglycidyl ether used to build the high molecular weight poly epoxy ester resins of the present invention are described herein below.

In general, the aliphatic or cycloaliphatic epoxy resin, component (a), for use in the polymerization of high molecular weight poly epoxy ester resin the present invention is prepared by a process (e.g. an epoxidation reaction) comprising reacting (1) an aliphatic or cycloaliphatic hydroxyl-containing material with (2) an epihalohydrin, and (3) a basic acting substance in the presence of (4) a catalyst. The process may optionally comprise (5) a solvent which is substantially inert to reaction with the reactants employed, the intermediates formed and the epoxy resin product produced. The catalyst is preferably a non-Lewis acid catalyst. Said process typically comprises the steps of (a) coupling of the epihalohydrin with the aliphatic or cycloaliphatic hydroxyl-containing material and (b) dehydrohalogenation of the intermediate halohydrin thus formed. The process may be, for example, a phase transfer catalyzed epoxidation process, a slurry epoxidation process, or an anhydrous epoxidation process. A detailed description of the aliphatic or cycloaliphatic epoxy resin and the processes for preparing the same is provided in WO2009/142901.

Aliphatic or cycloaliphatic hydroxyl-containing materials, component (1), which may be employed in the epoxidation process include for example any one or more of the compounds (A)-(G) listed as follows:

### (A) Cyclohexanedialkanols and Cyclohexenedialkanols

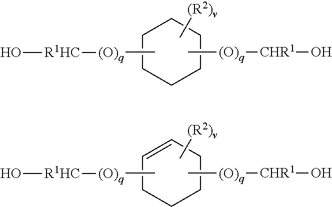

where each R¹ is independently —H or a C₁ to C₆ alkylene radical (saturated divalent aliphatic hydrocarbon radical), each R² is independently a C₁ to C₁₂ alkyl or alkoxy radical, a cycloalkyl or cycloalkoxy radical, or an aromatic ring or inertly substituted aromatic ring; each q independently has a value of 0 or 1; and v has a value of 0 to 2.

Representative preferred examples of the cyclohexanedialkanols and cyclohexenedialkanols include UNOXOL™ Diol (cis-, trans-1,3- and 1,4-cyclohexanedimethanol), cis-, trans-1,2-cyclohexanedimethanol; cis-, trans-1,3-cyclohexanedimethanol; cis-, trans-1,4-cyclohexanedimethanol; a methyl substituted cyclohexanedimethanol, such as, for example, a 4-methyl-1,2-cyclohexanedimethanol or 4-methyl-1,1-cyclohexanedimethanol; 1,1-cyclohexanedimethanol; a cyclohexenedimethanol such as, for example, 3-cyclohexene-1,1-dimethanol; 3 -cyclohexene-1,1-dimethanol, 6-methyl-; 4,6-dimethyl-3-cyclohexene-1,1-dimethanol; cyclohex-2-ene-1,1-dimethanol; 1,1-cyclohexanediethanol; 1,4-bis(2-hydroxyethoxy)cyclohexane; 1,4-cyclohexanediethanol; mixtures thereof and the like. Included within this class of epoxy resins are the cyclohexanedioxyalkanols and cyclohexenedioxyalkanols, where at least one q has a value of 1. Specific examples include 1,4-(2-hydroxyethyloxy)cyclohexane and 1,4-(2-hydroxyethyloxy)cyclohex-2-ene. All possible geometric isomers are intended by the formulas and in the aforementioned list, even if the isomers are not explicitly shown or given.

A representative synthesis of 1,1-cyclohexanedimethanol is given by Manea et al., in “1,1-Cyclohexanedimethanol-a New 1,3-Diol for Increased Stiffness in Polyurethane Elastomers,” Paint and Coatings Industry, Aug. 1, 2006, incorporated herein by reference in its entirety. A representative synthesis of 3-cyclohexene-1,1-dimethanol is described in U.S. Pat. No. 6,410,807 B1, incorporated herein by reference.

UNOXOL™ Diol (cis-, trans-1,3- and 1,4-cyclohexanedimethanol) is a preferred cyclohexanedialkanol. As used herein, the term “cis-, trans-1,3- and -1,4-cyclohexanedimethylether moiety” means a structure or a blend of chemical structures comprising four geometric isomers, a cis-1,3-cyclohexanedimethylether, a trans-1,3-cyclohexanedimethylether structure, a cis-1,4-cyclohexanedimethylether, and a trans-1,4-cyclohexanedimethylether, within an epoxy resin. The four geometric isomers are shown in the following structures:

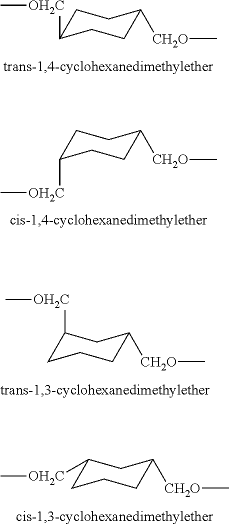

A detailed description of the epoxy resins comprising the cis-, trans-1,3- and 1,4-cyclohexanedimethylether moiety and the processes for preparing the same is provided in aforementioned WO/2009/142901. Phase transfer catalyzed epoxidation of aliphatic diols using quaternary ammonium halide catalysts with epichlorohydrin to produce aliphatic epoxy resins with properties that are superior to the corresponding aliphatic epoxy resins produced via Lewis acid catalyzed coupling with epichlorohydrin is described in EP Patent No. 121260B1 published Jul. 31, 1991 which is incorporated herein by reference. Included are epoxy resins prepared from cyclohexanedimethanol and dicyclopentadienedimethanol (isomers unspecified).

### (B) Cyclohexanolmonoalkanols and Cyclohexenolmonoalkanols

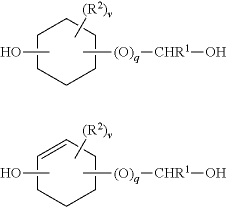

where each R¹, R², q and v are as hereinbefore defined.

Representative examples of the cyclohexanolmonoalkanols and cyclohexenolmonoalkanols which are aliphatic/cycloaliphatic hybrid diol structures containing one cyclohexanol or cyclohexenol moiety and one monoalkanol moiety, such as, for example, a monomethanol moiety, include, for example, 1-(hydroxymethyl)-cyclohexanol, 1-(hydroxymethyl)cyclohex-3-enol, 3-hydroxymethylcyclohexanol, 4-hydroxymethylcyclohexanol, rac-1-isopropyl-4-methyl-2-cyclohexene-1alpha,2alpha-diol; 5beta-isopropyl-2-methyl-3-cyclohexene-1alpha,2alpha-diol; 2-hydroxy methyl-1,3,3-trimethyl-cyclohexanol; cyclohexanol, 1-(2-hydroxyethoxy); mixtures thereof and the like. All possible geometric isomers are intended by the formulas and in the aforementioned list, even if the isomers are not explicitly shown or given.

Another example of such compounds is trans-2-(hydroxymethyl)-cyclohexanol prepared by Prins reaction on cyclohexane by Taira et al., “Experimental Tests of the Stereoelectronic Effect at Phosphorus: Nucleophilic Reactivity of Phosphite Esters, Journal of the American Chemical Society, 106, 7831-7835 (1984), incorporated herein by reference. A second example is 1-phenyl-cis-2-hydroxymethyl-r-1-cyclohexanol disclosed in U.S. Pat. No. 4,125,558, incorporated herein by reference. A third example is trans-4-(hydroxymethyl)cyclohexanol reported by Tamao et al., in Organic Syntheses, Collective, Volume 8, p. 315, Annual Volume 69, p. 96, incorporated herein by reference.

(C) Dec ahydronaphthalenedialkanols, Octahydronaphthalenedialkanols and 1,2,3,4-Tetrahydronaphthalenedialkanols

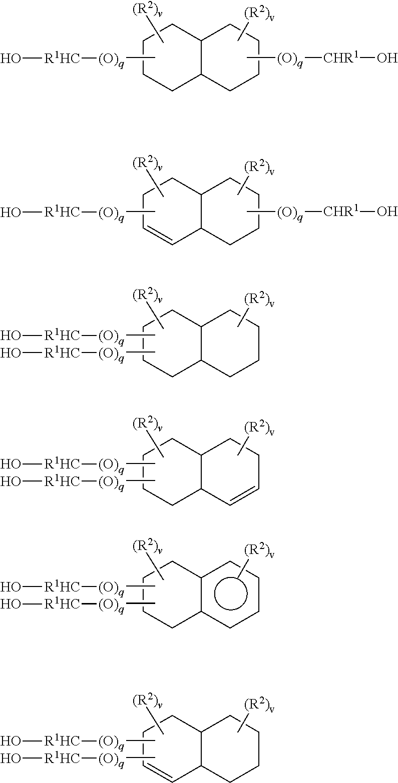

where each R¹, R², q and v are as hereinbefore defined.

Representative examples of the decahydronaphthalenedialkanols, octahydronaphthalenedialkanols and 1,2,3,4-tetrahydronaphthalenedialkanols containing one decahydronaphthalenedialkanol, octahydronaphthalenedialkanol or 1,2,3,4-tetrahydronaphthalenedialkanol moiety, include 1,2-decahydronaphthalenedimethanol; 1,3-decahydronaphthalenedimethanol; 1,4-decahydronaphthalenedimethanol; 1,5-decahydronaphthalenedimethanol; 1,6-decahydronaphthalenedimethanol; 2,7-decahydronaphthalenedimethanol;

1,2,3,4-tetrahydronaphthalenedimethanol (tetralin dimethanol); 1,2-octahydronaphthalenedimethanol; 2,7-octahydronaphthalenedimethanol; 4-methyl-1,2-decahydronaphthalenedimethanol; 4,5-dimethyl-2,7-decahydronaphthalenedimethanol; 1,2-decahydronaphthalenediethanol; 2,7-decahydronaphthalenediethanol; mixtures thereof and the like. All possible geometric isomers are intended by the formulas and in the aforementioned list, even if the isomers are not explicitly shown or given.

While not shown by the structures given above, it is intended that the hybrid diol structures also be included where one monoalkanol moiety is attached to a cycloaliphatic ring and one hydroxyl moiety is directly attached to a cycloaliphatic ring. One example of said hybrid structures would be 1-hydroxy-2-hydroxymethyldecahydronaphthalene.

### (D) Bicyclohexanedialkanols or Bicyclohexanolmonoalkanols

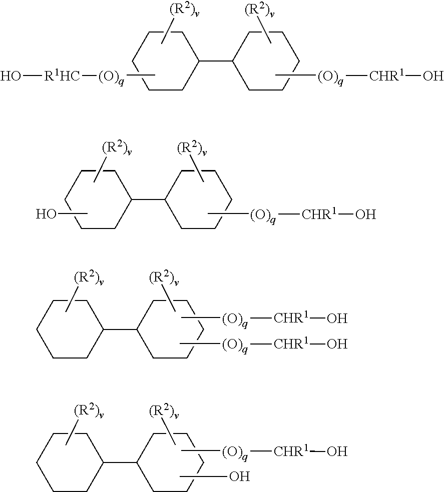

where each R¹, R², q and v are as hereinbefore defined.

Representative examples of the bicyclohexanedialkanols or bicyclohexanolmonoalkanols include bicyclohexane-4,4′-dimethanol; bicyclohexane-1,1′-dimethanol; bicyclohexane-1,2-dimethanol, bicyclohexane-4,4′-diethanol; bicyclohexane-1-hydroxy-1′-hydroxymethyl; bicyclohexane-4-hydroxy-4′-hydroxymethyl; mixtures thereof and the like. All possible geometric isomers are intended by the formulas and in the aforementioned list, even if the isomers are not explicitly shown or given.

While not shown by the structures given above, it is intended that epoxy resins of bicyclohexenedialkanols or bicyclohexenolmonoalkanols be included where either one or both rings may contain a single unsaturation. One example of said bicyclohexene structures would be the epoxy resin of bicyclohexene-1,1′-dimethanol.

### (E) Bridged Cyclohexanols

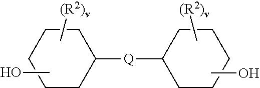

where each Q is a bridging group selecting from a C₁ to C₁₂ alkylene radical (saturated divalent aliphatic hydrocarbon radical), an arylene radical, O, S, O═S═O, S═O, C═O, R³NC═O, where R³ is —H or a C₁ to C₆ alkyl radical (saturated monovalent aliphatic hydrocarbon radical); R² and v are as hereinbefore defined.

Representative examples of the bridged cyclohexanols include the following compounds where the aromatic rings have been hydrogenated to cyclohexane rings: bisphenol A (4,4′-isopropylidenediphenol), bisphenol F (4,4′-dihydroxydiphenylmethane), 4,4′-dihydroxydiphenylsulfone; 4,4′-dihydroxybenzanilide; 1,1′-bis(4-hydroxyphenyl) cyclohexane; 4,4′-dihydroxydiphenyl oxide; 4,4′-dihydroxybenzophenone; 1,1-bis(4-hydroxyphenyl)-1-phenylethane; 4,4′-bis(4(4-hydroxyphenoxy)-phenylsulfone)diphenyl ether; 2,2′-sulfonyldiphenol; 4,4′-thiodiphenol; dicyclopentadiene diphenol.

### (F) Other Cycloaliphatic and Polycycloaliphatic Diols, Monol Monoalkanols, or Dialkanols

Most any cycloaliphatic or polycycloaliphatic diol, monol monoalkanol or dialkanol may be employed in the epoxidation process. Representative examples include the dicyclopentadienedimethanols, the norbornenedimethanols, the norbornanedimethanols, the cyclooctanedimethanols, the cyclooctenedimethanols, the cyclooctadienedimethanols, the pentacyclodecanedimethanols, the bicyclooctanedimethanols, the tricyclodecanedimethanols, the bicycloheptenedimethanols, the dicyclopentadienediols, the norbornenediols, the norbornanediols, the cyclooctanediols, the cyclooctenediols, the cyclooctadienediols, the cyclohexanediols, the cyclohexenediols, cyclopentane-1,3-diol; bicyclopentane-1,1′-diol; decahydronaphthalene-1,5-diol; trans,trans-2,6-dimethyl-2,6-octadiene-1,8-diol; 5-methylol-5-ethyl-2-(1,1-dimethyl-2-hydroxyethyl)-1,3-dioxane; 3,9-bis(1,1-dimethyl-2-hydroxyethyl)-2,4,8,10-tetraoxaspiro[5.5]undecane; 3-methyl-2,2-norbornanedimethanol; 5-norbornene-2,3-dimethanol; norbor nane-2,3-trans-dimethanol; perhydro-1,4:5,8-dimethanonaphthalene-2,3-trans-dimethanol; perhydro-1,4:5,8:9,10-trimethanoanthracene-2,3-trans-dimethanol; and 5-norbornene-2,3-dimethanol; norbornanolmonomethanols; and norbornenols.

Preparation of norbornane-2,3-trans-dimethanol; perhydro-1,4:5,8-dimethanonaphthalene-2,3-trans-dimethanol; and perhydro-1,4:5,8:9,10-trimethanoanthracene-2,3-trans-dimethanol are reported by Wilson et al., in “Polyesters Containing the Norbornane Structure”, Journal of Polymer Science: Polymer Chemistry Edition, volume 10, 3191-3204 (1972), incorporated herein by reference. Preparation of 5-norbornene-2,3-dimethanol is reported by Nakamura et al., in “Polyurethanes Containing a New Diol Segment, Synthesis of Polyurethanes Containing a Norbornene Moiety and Their Reactions with Thiols”, Macromolecules, 23, 3032-3035 (1990), incorporated herein by reference.

### (G) Aliphatic Hydroxyl-Containing Materials

Most any aliphatic hydroxyl-containing reactant may be employed in the epoxidation process, either alone, or in mixture with one or more aliphatic or cycloaliphatic hydroxyl-containing materials. Representative of the aliphatic hydroxyl-containing reactants include alkoxylated diphenolic reactants, such as, for example, ethoxylated catechol, ethoxylated resorcinol, ethoxylated hydroquinone, and ethoxylated bisphenol A. Alkoxylation products of the hydrogenated aromatic diphenolic reactants include ethoxylated hydrogenated bisphenol A. Other aliphatic hydroxyl-containing diol reactants include neopentyl glycol, ethylene glycol, propylene glycol, triethylene glycol, higher alkoxylated ethylene glycols, 1,4-butanediol; 1,6-hexanediol; and 1,12-dodecandiol.

Epihalohydrins, component (2), which may be employed in the epoxidation process include, for example, epichlorohydrin, epibromohydrin, epiiodohydrin, methylepichlorohydrin, methylepibromohydrin, methylepiiodohydrin, and any combination thereof. Epichlorohydrin is the preferred epihalohydrin.

The ratio of the epihalohydrin to the aliphatic or cycloaliphatic hydroxyl-containing material is generally from about 1:1 to about 25:1, preferably from about 1.8:1 to about 10:1, and more preferably from about 2:1 to about 5:1 equivalents of epihalohydrin per hydroxyl group in the aliphatic or cycloaliphatic hydroxyl-containing material. The term “hydroxyl group” used herein refers to the hydroxyl groups derived from the aliphatic or cycloaliphatic hydroxyl-containing material. Thus, the hydroxyl group differs from a secondary hydroxyl group formed during the process of the forming the halohydrin intermediate to the aliphatic or cycloaliphatic hydroxyl-containing material.

Basic acting substances, component (3), which may be employed in the epoxidation process to include alkali metal hydroxides, alkaline earth metal hydroxides, carbonates, bicarbonates, and any mixture thereof, and the like. More specific examples of the basic acting substance include sodium hydroxide, potassium hydroxide, lithium hydroxide, calcium hydroxide, barium hydroxide, magnesium hydroxide, manganese hydroxide, sodium carbonate, potassium carbonate, lithium carbonate, calcium carbonate, barium carbonate, magnesium carbonate, manganese carbonate, sodium bicarbonate, potassium bicarbonate, magnesium bicarbonate, lithium bicarbonate, calcium bicarbonate, barium bicarbonate, manganese bicarbonate, and any combination thereof. Sodium hydroxide and/or potassium hydroxide are the preferred basic acting substance.

Non-Lewis acid catalysts, component (4), which may be employed in the epoxidation process include, for example, ammonium, phosphonium, or sulfonium salts. More specific examples of the catalyst include salts of the following ammonium, phosphonium and sulfonium cations: benzyltributylammonium, benzyltriethylammonium, benzyltrimethylammonium, tetrabutylammonium, tetraoctylammonium, tetramethylammonium, tetrabutylphosphonium, ethyltriphenylphosphonium, triphenylsulfonium, 4-tert-butoxyphenyldiphenylsulfonium, bis(4-tert-butoxyphenyl)phenylsulfonium, tris(4-tert-butoxyphenyl)sulfonium, 3 -tert-butoxyphenyldiphenylsulfonium, bis(3-tert-butoxyphenyl)phenylsulfonium, tris(3-tert-butoxyphenyl)sulfonium, 3,4-di-tert-butoxyphenyldiphenylsulfonium, bis(3,4-di-tert-butoxyphenyl)phenylsulfonium, tris(3,4-di-tert-butoxyphenyl)sulfonium, diphenyl(4-thiophenoxyphenyl)sulfonium, 4-tert-butoxycarbonylmethyloxyphenyldiphenylsulfonium, tris(4-tert-butoxycarbonylmethyloxyphenyl)sulfonium, (4-tert-butoxyphenyl)bis(4-dimethylaminophenyl)sulfonium, tris(4-dimethylaminophenyl)sulfonium, 2-naphthyldiphenylsulfonium, (4-n-hexyloxy-3,5-dimethylphenyl)diphenylsulfonium, dimethyl(2-naphthyl)sulfonium, 4-methoxyphenyldimethylsulfonium, trimethylsulfonium, 2-oxocyclohexylcyclohexylmethylsulfonium, trinaphthylsulfonium, tribenzylsulfonium, diphenylmethylsulfonium, dimethylphenylsulfonium, 2-oxo-2-phenylethylthiacyclopentanium, diphenyl-2-thienylsulfonium, 4-n-butoxynaphthyl-1thiacyclopentanium, 2-n-butoxynaphthyl-1-thiacyclopentanium, 4-methoxynaphthyl-1thiacyclopentanium, and 2-methoxynaphthyl-1-thiacyclopentanium. Preferred cations are triphenylsulfonium, 4-tert-butylphenyldiphenylsulfonium, 4-tert-butoxyphenyldiphenylsulfonium, tris(4-tert-butylphenyl)sulfonium, tris(4-tert-butoxyphenyl)sulfonium, dimethylphenylsulfonium, and any combination thereof. Suitable quaternary phosphonium catalysts also include, for example, those quaternary phosphonium compounds disclosed in U.S. Pat. Nos. 3,948,855; 3,477,990 and 3,341,580 and Canadian Patent No. 858,648 all of which are incorporated herein by reference. Benzyltriethylammonium halides are the preferred catalyst, with benzyltriethylammonium chloride being most preferred.

While the amount of catalyst may vary due to factors such as reaction time and reaction temperature, the lowest amount of catalyst to produce the desired effect is preferred. In general, the catalyst may be used in an amount of from about 0.5 percent by weight (wt %) to about 25 wt %, preferably, from about 1 wt %to about 18 wt %, and more preferably, from about 2 wt % to about 12 wt %, based on the total weight of the aliphatic or cycloaliphatic hydroxyl-containing material.

The epihalohydrin may function as both a solvent, component (5), and a reactant in the epoxidation. Alternatively, a solvent other than the epihalohydrin may also be used in the process for preparing the aliphatic or cycloaliphatic epoxy resin (a). The solvent other than the epihalohydrin should be inert to any materials used in the process of preparing the aliphatic or cycloaliphatic epoxy resin (a), including for example, reactants, catalysts, intermediate products formed during the process, and final products. Solvents which may optionally be employed in the epoxidation process include, for example, aliphatic and aromatic hydrocarbons, halogenated aliphatic hydrocarbons, aliphatic ethers, aliphatic nitriles, cyclic ethers, ketones, amides, sulfoxides, tertiary aliphatic alcohols, and any combination thereof.

Particularly preferred solvents, component (5), include pentane, hexane, octane, toluene, xylene, methylethylketone, methylisobutylketone, N,N-dimethylformamide, dimethylsulfoxide, diethyl ether, tetrahydrofuran, 1,4-dioxane, dichloromethane, chloroform, ethylene dichloride, methyl chloroform, ethylene glycol dimethyl ether, N,N-dimethylacetamide, acetonitrile, tertiary-butanol, and any combination thereof.

If the solvent other than the epihalohydrin is employed in the epoxidation process, the minimum amount of solvent to achieve the desired result is preferred. In general, the solvent may be present in the process from about 120 wt % to about 5 wt %, preferably, about 30 wt % to about 100 wt %, and more preferably, about 50 wt % to about 80 wt %, based on the total weight of the aliphatic or cycloaliphatic hydroxyl-containing material. The solvent may be removed from the final product at the completion of the reaction of forming the epoxy resin using conventional methods, such as vacuum distillation.

Epoxy resins of cycloaliphatic or polycycloaliphatic diols may beneficially be employed in a mixture with one or more of the epoxy resins selected from the epoxy resins prepared from aliphatic or cycloaliphatic hydroxyl-containing materials in (A)-(G) above to provide additional advanced high molecular weight poly epoxy ester resin compositions of the present invention. Epoxy resins of other kinds of diols, which are not shown in (A)-(G) above, may also beneficially be employed in a mixture comprising one or more of the epoxy resins selected from the epoxy resins of aliphatic or cycloaliphatic hydroxyl-containing materials in (A)-(G) above to provide additional advanced high molecular weight poly epoxy ester resin compositions of the present invention.

Epoxy resins prepared from reaction of aliphatic and cycloaliphatic diols using non-Lewis acid processes typically contain a significant amount of oligomeric product with an epoxide functionality of greater than 2. Because of the presence of functionality higher than 2 epoxide groups per molecule, an excess of these oligomers can induce unwanted branching, excessive viscosity, premature crosslinking or gelation. Thus, the epoxy resins used to prepare the compositions of the present invention should have an amount of diglycidyl ether component which allows the advancement reaction to progress to completion without the aforementioned problems. Thus, the amount of oligomer content in the epoxy resin is generally 0 wt % to about 10 wt %, preferably 0 wt % to about 5 wt %, and more preferably 0 wt % to less than about 0.5 wt %, by weight of the epoxy resin.

Monoglycidyl monol ethers may also comprise a component of the epoxy resins used to prepare the compositions of poly epoxy ester resins in the present invention. Because the monoglycidyl ether component generally functions as a chain terminator in the advancement reaction, it is present in an amount which does not hinder the desired extent of molecular weight build and other such properties. Thus, the amount of monoglycidyl ether in the epoxy resin is generally 0 wt % to about 20 wt %, preferably 0 wt % to about 10 wt % and more preferably 0 wt % to less than about 5 wt %, by weight of the epoxy resin.

Other minor components may be present as a component of the epoxy resin used to prepare the compositions of the present invention. Generally, said minor components may be present in an amount of from 0 wt % to about 5 wt %, preferably 0 wt % to about 2 wt % and more preferably 0 wt % to less than about 0.5 wt %, based on the weight of the epoxy resin.

The aromatic dicarboxylic acids in our invention may comprise any substituted or unsubstituted aryl structures bearing two carboxylic acid groups in any ring positions. The aryl structures may comprise benzene, substituted benzene, naphthalene, substituted naphthalene and any ring-annulated benzene, or the combination of aryl and aliphatic substitute groups.

The aromatic dicarboxylic acids useful as component (b) in the advancement reaction to produce the high molecular weight poly epoxy ester resin product of the present invention may include aromatic dicarboxylic acids having the following general structure, Structure (II):

HOOC—Ar—COOH

### Structure (II)

where Ar is a divalent aryl group or heteroarylene group. The aromatic dicarboxylic acid useful in the present invention may include, but is not limited to, a phthalic acid, a substituted phthalic acid, an isophthalic acid, a terephthalic acid, a 2,6-naphthalene dicarboxylic acid, a naphthalene dicarboxylic acid with the two —COOH group at any substitute positions, any aromatic compound with dicarboxylic acid structures , and mixtures thereof and the like.

One preferred example of aromatic dicarboxylic acid to build new high molecular weight poly epoxy ester resins in this invention is 2,6-naphthalene dicarboxylic acid.

The resultant high molecular weight poly epoxy ester resin contains ester linkages and hydroxyl groups characteristic of the poly epoxy ester resin advancement reaction.

The monomer molar ratios between the component (a), a cycloaliphatic diglycidyl ether compounds, such as a mixture of 1,3 and 1,4 cis and trans cyclohexanedimethanol diglycidyl ether (e.g. UNOXOL™ Diol DGE), and component (b), an aromatic dicarboxylic acid, may vary from about 5:1 to about 1:5, preferably from about 1:1.5 to about 1.5:1, and more preferably from about 1:1.1 to about 1.1:1. The monomer molar ratios are use to obtain high molecular weight poly epoxy ester resins. As described in polymer textbooks, such as George Odian in Principles of Polymerization, 4^{th} edition, a near stoichiometric monomer ratio, e.g. molar ratio between cylcoaliphatic diglycidyl ether and aromatic dicarboxylic acid from about 1.1:1 to about 1:1.1, is used to prepare substantially linear high molecular weight poly epoxy ester resins. A significant deviation from stoichiometric monomer ratio would lead to oligomers or low molecular weight epoxy products.

In one preferred embodiment of the present invention, a monophenolmonocarboxylic acid is employed for the advancement reaction to produce not only ester moieties derived from reaction of the epoxide group and carboxylic acid group, but also ether moieties derived from reaction of the epoxide group and phenolic hydroxyl group. A representative example of this hybrid ether and ester advancement reaction product follows where a hydroxybenzoic acid and an epoxy resin of a cyclohexane dimethanol are reacted as illustrated by the following reaction Scheme (II):

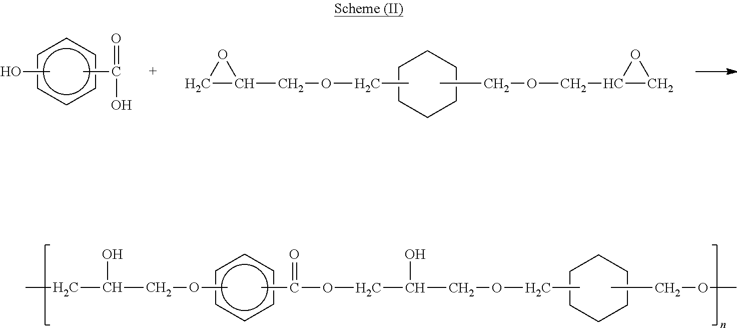

Suitable monophenolmonocarboxylic acids are represented by the following formula Structures (III):

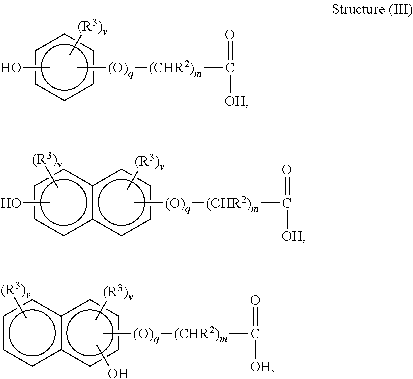

where each R² is independently —H or a C₁ to C₆ alkylene radical (saturated divalent aliphatic hydrocarbon radical), each R³ is independently a C₁ to C₁₂ alkyl or alkoxy radical, a cycloalkyl or cycloalkoxy radical, or an aromatic ring or inertly substituted aromatic ring; each q independently has a value of 0 or 1; v has a value of 0 to 2; m has a value of 0 or 1; with the proviso that when q has a value of 1 then m also has a value of 1.

Representative of the monophenolmonocarboxylic acids are p-hydroxybenzoic acid, o-hydroxybenzoic acid, m-hydroxybenzoic acid, p-hydroxyphenylacetic acid, 1-hydroxy-4-carboxynaphthalene, 2-hydroxy-7-carboxynaphthalene, mixtures thereof and the like.

In another embodiment of the present invention, use of a reactant with moieties possessing different reactivity toward the epoxide group can be employed to provide a reactive oligomeric product, either in situ or in a separate reaction, which can then be further reacted to give an advancement reaction product of the present invention. This reactive oligomeric product can then be further reacted with the same or different reactants to produce an advanced poly epoxy ester resin product of the present invention.

As a representative example, a monophenolmonocarboxylic acid may be reacted with an epoxy resin under conditions which substantially favor reaction of the carboxylic acid moiety leaving the phenolic hydroxyl moiety substantially unreacted. The resultant phenolic hydroxyl terminated product may then be reacted with an additional epoxy resin or an additional epoxy resin plus additional difunctional reactant to produce the advancement product of the present invention. As another representative example, a diphenol may be reacted with an epoxy resin to produce an epoxy terminated oligomer product. The resultant epoxy terminated oligomer product may then be reacted with an additional aromatic dicarboxylic acid or an additional epoxy resin plus additional difunctional reactant to produce the advancement product of the present invention. This method beneficially allows for incorporation of different structures into the product as well as control of the position of various chemical structures within the product.

As a representative example, a monophenolmonocarboxylic acid may be reacted with an epoxy resin under conditions which substantially favor reaction of the carboxylic acid moiety leaving the phenolic hydroxyl moiety substantially unreacted. The resultant phenolic hydroxyl terminated product may then be reacted with an additional epoxy resin or an additional epoxy resin plus additional difunctional reactant to produce the advancement product of the present invention. This embodiment beneficially allows for incorporation of different structures into the product as well as control of the position of various chemical structures within the product.

### Monofunctional Components for Advancement Reaction

The advancement reaction product of the present invention may contain unreacted epoxide groups which terminate the oligomer chains. Likewise the advancement reaction product may contain unreacted groups from the difunctional reactant, such as, for example, aromatic carboxylic acid groups, which terminate the oligomer chains. Thus, for certain applications, it may be beneficial to react all or a part of one or both types of terminating end groups with one or more monofunctional reactants. A specific example follows where an aromatic dicarboxylic acid and an epoxy resin of a cyclohexane dimethanol are reacted and residual terminating epoxide group of the resultant advanced product is then reacted with an aromatic monocarboxylic acid as illustrated by the following reaction Scheme (III).

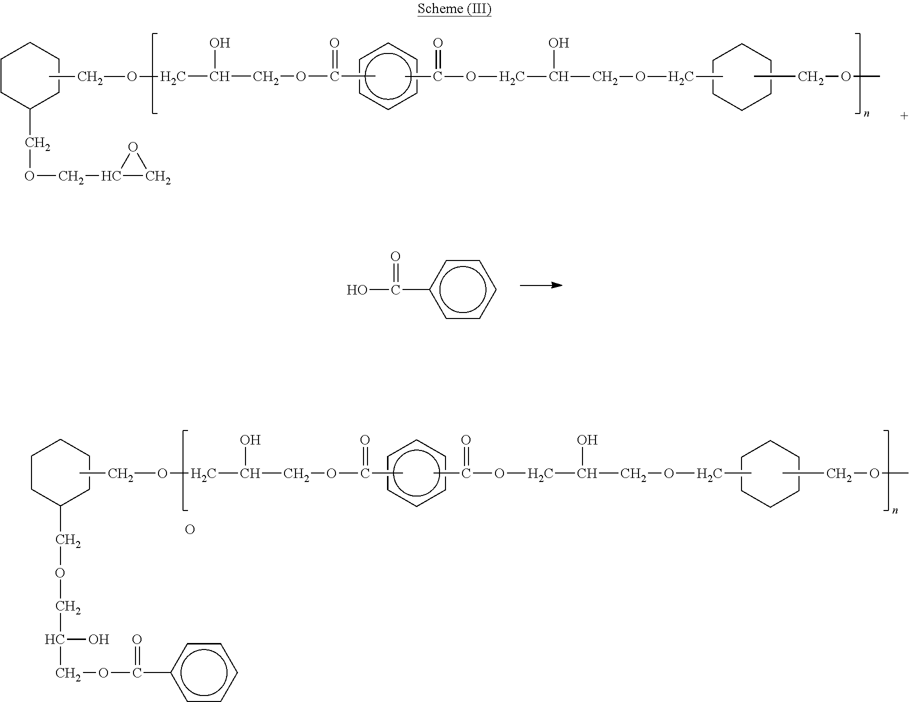

Terminal epoxide groups may be reacted with any monofunctional compound containing a single epoxide-reactive group and, likewise, the terminal group derived from the difunctional reactant may be reacted with any monofunctional compound containing a single reactive group. Representative of the monofunctional reactants for reaction with a terminal epoxide group include phenol, substituted phenols, naphthols, substituted naphthols, benzoic acid, substituted benzoic acids, phenylacetic acid, substituted phenylacetic acids, cyclohexane monocarboxylic acid, substituted cyclohexane monocarboxylic acids, naphthalene monocarboxylic acid, aliphatic monocarboxylic acids, such as, for example, hexanoic acid, acrylic acid, methacrylic acid and the like; secondary monoamines, such as, for example, N-methylcyclohexylamine or dihexylamine; dialkanolamines, such as, for example diethanolamine; mixtures thereof and the like.

Terminal carboxylic acid groups may be reacted with a monoepoxide, such as, for example, phenylglycidyl ether, the monoglycidyl ether of cyclohexanol, or the monoglycidyl ether monol of cyclohexanedimethanol.

It may also be possible to incorporate one or more monofunctional reactants directly into the synthesis of the poly epoxy ester resin to terminate the chains of the advancement product, control molecular weight build, modify cure characteristics of the final product, modify physical or mechanical properties of the cured product therefrom, and for other reasons desired by a skilled artisan.

The advancement reaction products modified via reaction with one or more monofunctional reactants in the manner given above may possess enhanced physical and/or mechanical properties useful for various applications such as for can coating resins prepared therefrom. Thus modification of properties such as adhesion to a metal substrate, toughness, processability, and other improved properties may be achieved.

Other acid function providing monomers such as non-aromatic diacids or anhydrides may be used in addition to the aromatic diacid. The non-aromatic diacids or anhydrides may be saturated or or contain a double bond which is polymerizable by free radical mechanism. Maleic acid anhydride may be an example of an acid function providing monomer having a double bond which is polymerizable by free radical mechanism. The introduction of a double bond which is polymerizable by free radical mechanism into the backbone of the resulting poly epoxy ester resin could be useful as reaction site with other acid functional monomers which are polymerizable by free radical mechanism, such as (meth) acrylic acid and vinylic monomers not containing an acid group such as acrylic acid esters, styrene and the like, rendering resins which can be dispersed by at least partially neutralizing of the derived modified product with a base such as dimethanol amine applying the methods known to those skilled in the art to make waterborne dispersions as described, for example, in WO2005080517, incorporated herein by reference.

The preparation of a high molecular weight poly epoxy ester resin of the present invention is achieved by adding to a reactor: a cycloaliphatic diglycidyl ether, an aromatic dicarboxylic acid, optionally a catalyst, and optionally a solvent; and then allowing the components to react under reaction conditions to produce the high molecular weight poly epoxy ester resin. The components may be mixed in any order. The components are heated until the desired degree of reaction is achieved.

The reaction conditions to form the high molecular weight poly epoxy ester resin include carrying out the reaction under a temperature, generally in the range of from about 20° C. to about 250° C.; preferably from about 100° C. to about 250° C.; more preferably, from about 125° C. to about 225° C.; and even more preferably, from about 150° C. to about 200° C. The pressure of the reaction may be generally from about 0.1 bar to about 10 bar; preferably, from about 0.5 bar to about 5 bar: and more preferably, from about 0.9 bar to about 1.1 bar.

In a preferred embodiment, one or more suitable reaction catalysts may be employed in the practice of the present invention. Catalysts used to prepare the compositions of the present invention may be selected, for example, from one or more of, metal salts such as an alkali metal salt, an alkaline earth metal salt, a tertiary amine, a quaternary ammonium salt, a sulfonium salt, a quaternary phosphonium salt, a phosphine and the like, and mixtures thereof. Preferably, the catalyst used in the present invention is tetraphenylphosphonium bromide, any aliphatic or aromatic substituted phenylphosphonium bromide or mixtures thereof.

The reaction catalyst is generally employed in an amount of from about 0.0010 wt % to about 10 wt %; preferably from about 0.01 wt % to about 10 wt %; more preferably from about 0.05 wt % to about 5 wt %, and even more preferably from about 0.1 wt % to about 4 wt %, based on the combined weight of monomer compounds used.

The reaction process to prepare the high molecular weight poly epoxy ester resin of the present invention may be batch or continuous. The reactor used in the process may be any reactor and ancillary equipment well known to those skilled in the art.

The examples of polymer modifications to the advanced poly epoxy ester resin of the present invention include, but not are limited to, capping of the poly epoxy ester resin with unsaturated acid monomers such as acrylic acids for radiation curing applications, making water dispersible resins for use in waterborne spray and roller coat applications for beverage and food cans. For example, the advanced epoxy resin of the present invention may be made water dispersible as follows: (i) by adding water dispersible acrylic or polyester resins, (ii) by extending the epoxy resin with water dispersible acrylic or polyester resins, (iii) by grafting with unsaturated acid monomers such as (meth) acrylic acid and vinylic monomers not containing an acid group such as acrylic acid esters, styrene and the like, (iv) by reacting with phosphoric acid and water and the like or (v) by at least partially neutralizing of the reaction product of (i) to (iv) above with a base such as dimethanol amine applying the methods known to those skilled in the art to make water dispersible epoxy resins and polyesters and rendering waterborne dispersions as described, for example, in EP17911, U.S. Pat. No. 6,306,934, WO2000039190, WO2005080517, incorporated herein by reference.

The resin of the present invention as such could further undergo additional processes such as hydrogenation of any unsaturations or aromatic moieties to yield a resin which is fully saturated.

The advanced high molecular weight poly epoxy ester resin compositions of the present invention are preferably polymers with weight average molecular weight of generally between about 300 to about 1,000,000, preferably from about 1,000 to about 500,000, more preferably from about 2,000 to about 100,000, even more preferably from about 4,000 to about 50,000, most preferably from about 5,000 to about 40,000, and even most preferably from about 7,000 to about 30,000.

The high molecular weight poly epoxy ester resin compositions of the present invention have unusually high flexibility and high toughness at room temperature. The material flexibility and toughness were characterized by stress-strain behavior of the poly epoxy ester resin. Elongation to break is a common parameter to measure the flexibility and tensile toughness which are fundamental mechanical properties of materials. The tensile toughness is a measure of the ability of a material to absorb energy in a tensile deformation. The elongations to break of the poly epoxy ester resins of the present invention are over about 100 to over about 1000 times higher than a typical prior known 9-type bisphenol A advanced based epoxy resin. In addition, the tensile toughnesses of the poly epoxy ester resins of the present invention are over about 100 times stronger than a typical prior known 9-type bisphenol A advanced based epoxy resin.

The glass transition temperature of the advanced poly epoxy ester resins is generally between about −50° C. to about 200° C., preferably from about 0° C. to about 150° C., more preferably from about 10° C. to about 120° C., and even more preferably from about 20° C. to about 100° C. and most preferably from about 25° C. to about 90° C.

The elongation at break of the advanced poly epoxy ester resins at room temperature is generally between about 4 percent (%) to about 10,000%, preferably from about 10% to about 5000%, more preferably from about 20% to about 4000%, even more preferably from about 30% to about 3000%, still more preferably from about 40% to about 2000%, most preferably from about 50% to about 1500%, even most preferably from about 60% to about 1200%, and still most preferably from about 80% to about 1100%.

The tensile toughness of the advanced poly epoxy ester resins at room temperature is generally between about 0.05 MPa to about 500 MPa, preferably from about 0.05 MPa to about 500 MPa, more preferably from about 0.1 MPa to about 100 MPa, even more preferably from about 0.5 MPa to about 50 MPa, still more preferably from about 0.8 MPa to about 30 MPa, most preferably from about 1.0 MPa to about 20 MPa, event most preferably from about 2.0 MPa to about 15 MPa, and still most preferably from about from about 3.0 MPa to about 10 MPa.

Another embodiment of the present invention is directed to a curable high molecular weight poly epoxy ester resin composition comprising (i) the above advanced poly epoxy ester resin of Structure (I); (ii) at least one curing agent; (iii) at least one curing catalyst; (iv) optionally, at least one solvent; and (v) optionally, at least one additive.

Component (i) useful for preparing the curable advanced poly epoxy ester resin composition of the present invention may comprise, for example, the above high molecular weight poly epoxy ester resin of Structure (I).

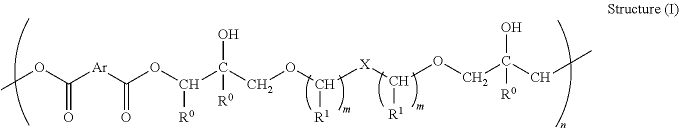

where n is a number from 2 to about 3000; each m independently has a value of 0 or 1; each R⁰ is independently —H or —CH₃; each R¹ is independently —H or a C₁ to C₆ alkylene radical (saturated divalent aliphatic hydrocarbon radical), Ar is a divalent aryl group or heteroarylene group; and X is cycloalkylene group, including substituted cycloalkylene group, where the substitute group include an alkyl, cycloalkyl, an aryl or an aralkyl group or other substitute group, for example, a halogen, a nitro, or an alkyloxy group; the combination of cycloalkylene and alkylene groups and the combination of alkylene and cycloalkylene group with a bridging moiety in between.

The concentration of first component (i), the high molecular weight poly epoxy ester resin, used in the curable poly epoxy ester resin composition of the present invention may range generally from about 99.9 wt % to about 10 wt %; preferably from about 99 wt % to about 50 wt %; more preferably from about 98 wt % to about 75 wt %; and most preferably, from about 95 wt % to about 85 wt %. Generally, the amount of high molecular weight poly epoxy ester resin used is selected based on the desired balance of properties of the resulting cured product.

A curing agent useful for the curable high molecular weight poly epoxy ester resin composition of the present invention may comprise any conventional curing agent known in the art for curing epoxy resins such as for example an epoxy resin, a phenolic resole, an amino formaldehyde resin, an amido formaldehyde resin or an anhydride resin, and the like. The crosslinker (curing agent) may also selected from crosslinkers with other reactive groups such as active alcoholic (—OH) groups, e.g. alkylol such as ethylol or other methylol groups, epoxy group, carbodiimide group, isocyanate group, aziridinyl group, oxazoline group, acid groups and anhydride groups, i-butoxymethylacrylamide and n-butoxymethylacrylamide groups and the like; unsaturated groups cured with an radial initiator and/or radiation, and mixtures thereof.

The ratios between the high molecular weight poly epoxy ester resin, component (i); and the crosslinker component (ii) of the curable high molecular weight poly epoxy ester resin composition, may vary depending various factors such as the type of crosslinker used and the amount of curable moieties present in the advanced epoxy resin. However, in general the weight ratio may be from 0 wt % to about 90 wt %, preferably from about 1 wt % to about 50 wt %, more preferably from about 2 wt % to about 25 wt %, and most preferably from about 5 wt % to about 15 wt %. The amount of the curing agent used in the curable advanced high molecular weight poly epoxy ester resin composition generally is selected based on the desired balance of properties of the resulting cured product.

In preparing the curable advanced high molecular weight poly epoxy ester resin composition of the present invention, at least one curing catalyst may be used to facilitate the curing reaction of the advanced high molecular weight poly epoxy ester resin with the at least one curing agent. The curing catalyst useful in the present invention may include, for example an acid such as phosphoric acid or an organosulfonic acid or a base such as a tertiary amine; amine or an organometallic compound such as organic derivative of tin, bismuth, zinc, or titanium or an inorganic compound such as oxide or halide of tin, iron, or manganese; and mixtures thereof. The curing catalyst is generally employed in an amount of from about 0.01 wt % to about 10 wt %; preferably from about 0.05 wt % to about 5 wt %, and most preferably from about 0.1 wt % to about 2 wt %, based on the combined weight of the advanced poly epoxy ester resin and curing agent used.

Also to facilitate the curing of high molecular weight poly epoxy ester resin with the at least one curing agent, a solvent may be used in preparing the curable high molecular weight poly epoxy ester resin composition of the present invention. For example, one or more organic solvents well known in the art may be added to the advanced high molecular weight poly epoxy ester resin composition. For example, aromatics such as xylene, ketones such as methyl ethyl ketone and cyclohexanone, and ethers such as monobutyl ethylene glycol ether and diethylene glycol dimethyl ether (diglyme); alcohols such as butanol, and mixtures thereof, may be used in the present invention.

The concentration of the solvent used in the present invention may range generally from 0 wt % to about 90 wt %, preferably from about 0.01 wt % to about 80 wt %, more preferably from about 1 wt % to about 70 wt %, and even more preferably from about 10 wt % to about 60 wt %. Viscosity is too high or solvent wasted when the above concentration ranges are not used.

Additives known useful for the preparation, storage, application, and curing of the typical advanced epoxy resin composition may be used in the curable high molecular weight poly epoxy ester resin composition as optional additional elements, such as reaction catalysts, resin stabilizers, defoamers, wetting agents, curing catalysts, pigments, dyes and processing aids. An assortment of additives may be optionally added to the compositions of the present invention including for example, other catalysts, solvents, other resins, stabilizers, fillers such as pigments and dyes, plasticizers, catalyst de-activators, and mixtures thereof.

Other optional additives that may be added to the curable composition of the present invention may include, for example, wetting agents, lubricants, defoamers, fillers, adhesion promoters, slip agents, anti cratering agents, plasticizers, catalyst de-activators, polymeric coreactants such as an acrylic resin or polyester resin; resins such as polyesters, acrylic resins, polyolefins, urethane resins, alkyd resins, polyvinylacetates, epoxy resins, vinyl resins; dispersion with acid functional/non ionic surfactants in water; and mixtures thereof and the like.

The curable advanced high molecular weight poly epoxy ester resin composition formulation or composition of the present invention can be cured under conventional processing conditions to form a film, a coating, a foam or a solid. The process to produce the cured advanced high molecular weight poly epoxy ester resin products of the present invention may be performed by gravity casting, vacuum casting, automatic pressure gelation (APG), vacuum pressure gelation (VPG), infusion, filament winding, lay up injection, transfer molding, prepreging, coating, such as roller coating, dip coating, spray coating and brush coating, and the like.

The curing reaction conditions include, for example, carrying out the reaction under a temperature, generally in the range of from about 0° C. to about 300° C.; preferably, from about 20° C. to about 250° C.; and more preferably, from about 100° C. to about 220° C.

The pressure of the curing reaction may be carried out, for example, generally at a pressure of from about 0.01 bar to about 1000 bar; preferably, from about 0.1 bar to about bar 100; and more preferably, from about 0.5 bar to about 10 bar.

The curing of the curable advanced poly epoxy ester resin composition may be carried out, for example, for a predetermined period of time sufficient to cure or partially cure (B-stage) the composition. For example, generally the curing time may be chosen between about 2 seconds to about 24 hours, preferably between about 5 seconds to about 2 hours, more preferably between about 5 seconds to about 30 minutes, and even more preferably between about 8 seconds to about 15 minutes. A B-staged composition of the present invention may then be completely cured at a later time using the aforementioned conditions.

The curing process of the present invention may be a batch or a continuous process. The reactor used in the process may be any reactor and ancillary equipment well known to those skilled in the art.

The resulting cured advanced poly epoxy ester resin composition displays excellent thermo-mechanical properties, such as good flexibility measured by Wedge Bend

Flexibility. The failure percentage measured by Wedge Bend Flexibility of the resulting cured advanced poly epoxy ester resin compositions is generally below about 50%, preferably below about 25%, more preferably below about 15%, even more preferably below about 10%, still more preferably below about 5%, most preferably below about 4%, even most preferably below about 3%, still most preferably below about 2%, and yet most preferably below about 1%.

The resulting cured advanced poly epoxy ester resin composition displays good chemical solvent resistance, such as solvent resistance measured by MEK Double Rub. The solvent resistance measured by MEK Double Rub of the resulting cured advanced poly epoxy ester resin compositions is generally above about 25, preferably above about 50, more preferably between about 50 to about 200, even more preferably between about 50 to about 150, and most preferably between about 50 to about 125.

The curable advanced high molecular weight poly epoxy ester resin compositions of the present invention are useful for the preparation of cured advanced high molecular weight poly epoxy ester resin in the form of coatings, films, adhesives, laminates, composites, electronics, and the like.

As an illustration of the present invention, in general, the curable advanced high molecular weight poly epoxy ester resin compositions may be useful for coating casting, potting, encapsulation, molding, and tooling. The resulting cured advanced high molecular weight poly epoxy ester resin composition may be useful in some applications, such as encapsulations, castings, moldings, potting, encapsulations, injection, resin transfer moldings, composites, coatings and the like.

### EXAMPLES

The following examples and comparative examples further illustrate the present invention in detail but are not to be construed to limit the scope thereof.

Various terms and designations are used in the following Examples, including for example the following:

UNOXOL™ Diol is a mixture of cis-, trans-1,3- and 1,4-cyclohexanedimethanol obtained from The Dow Chemical Company. A high purity (>99.0 area % by gas chromotography) product mixture of diglycidyl ether of cis-, trans-1,4-cyclohexanedimethanol and a product mixture of a diglycidyl ether of cis-1,3-cyclohexanedimethanol, a diglycidyl ether of trans-1,3-cyclohexanedimethanol, a diglycidyl ether of cis-1,4-cyclohexanedimethanol, a diglycidyl ether of trans-1,4-cyclohexaneimethanol (UNOXOL™ Diol DGE) were obtained and purified according to WO2009/142901. Likewise, a high purity product mixture of diglycidyl ether of cis-, trans-1,4-cyclohexanedimethanol (1,4- —CHDM DGE) was prepared and purified using the same method provided above.

Methylon 75108 is an allyl ether phenol-based phenolic resin crosslinker obtained from Durez Corporation. Byk-310 is a kind of silicone additive obtained from Byk Chemie. DER™ 669E is a bisphenol A based high molecular weight 9-type epoxy resin product obtained from The Dow Chemical Company. Catalyst A2 is a 70% tetrabutylphosphonium acetate-acetic acid complex in methanol obtained from Deepwater Chemicals. All other chemicals were obtained from Sigma-Aldrich used as received, except where otherwise noted.

Standard analytical equipment and methods are used in the following Examples, including for example the following:

Molecular Weight Measurement

Gel permeation chromatography (GPC) is used to measure the molecular weight and molecular weight distribution of advanced high molecular weight poly epoxy ester resins. The polymeric samples were diluted to about 0.25 wt % concentration with eluent and analyzed using the conditions below: columns: Polymer Labs 5 μm, 50 Å, 100 Å, 1000 Å, and 10000 Å mono-pore size columns (4 in series); detector: Viscotek TDA 302 with triple-detection system. Differential reflective index (DRI) detector was used for relative MW calculations; eluent: Tetrahydrofuran; flow: 1 mL/min; temperature: 40° C.; injection: 100 μL; calibration: Polymer Laboratories PS-2 linear polystyrene with 3rd order fitting.

Glass Transition Temperature Measurement

Differential scanning calorimetry (DSC) is used to characterize the glass transition temperature (Tg) of advanced high molecular weight poly epoxy ester resins. The equipment is Q1000 DSC from TA Instruments and the testing conditions are two heating and one cooling scans between −50° C. and 250° C. at 10° C./min under nitrogen. The reported Tg was calculated from the second heating scan.

Microtensile Measurement

Tensile test is a common measurement used in the industry for many years to characterize toughness, elongation and the ability to resist failure under tensile stress. Stress-strain behavior of advanced poly epoxy ester resins is measured using ASTM D 1708 microtensile specimens. This microtensile test consists of pulling a sample of material until it breaks with an Instron™ at 20 mm/min at 21° C. with a 200 lb load cell with pneumatic grips. The specimens tested may have a rectangular cross section. From the load and elongation history, a stress-strain curve is obtained with the strain being plotted on the x-axis and stress on the y-axis. The elongation at break is defined as the strain at which the specimen breaks. The tensile toughness is defined as the area under the entire stress-strain curve up to the fracture point. Tensile toughness and elongation at break are reported from an average of 5 specimens.

Coating Thickness Measurements

The thickness measurements are performed basically according to A.S.T.M. D 1186-93; “Non-destructive measurement of dry film thickness of non magnetic coatings applied to a ferrous base” using a PERMASCOPE D-211D, coating thickness gauge.

The sample panel without any coating is zeroed in and then coated panels are measured using a probe for ferrous materials and the measured thickness is reported in micron [μm].

Methyl Ethyl Ketone (MEK) Double Rubs Test

The MEK test is performed basically according to A.S.T.M. D 5402. The flat end of a hammer hemispherical having a weight of two pounds is used. A normal cheese cloth “VILEDA 3168” is bound around the hammer end. It is soaked with MEK. The hammer is brought onto the coating and moved forth-and-back over the whole coating, being one double rub. Care should be taken not to put any pressure on the hammer. After every 25 double rubs the tissue is re-soaked. This is repeated until the coating is rubbed off to such an extent that the coating is scratched. This procedure is carried out until the maximum of 200 are reached.

Wedge Bend Flexibility Test

The wedge bend test is carried out as follows: A tapered 180 degree bend in the panel is formed by first bending it to 180° with a radius of about 0.5 cm and coating on the outside of the bend. Then one side of the bend was completely flattened to a near zero radius with an impactor at 40 in. lbs. The stressed surface is subjected to a tape pull and then rubbed with a solution of copper sulfate (mixture of 10 gr. of copper sulfate, 90 gr. of water and 3 gr. of sulfuric acid). Anywhere the coating has cracked dark spots appear indicating failure. The amount of coating failure (in mm) along the length of the wedge bend, which is 100 mm, is recorded as “% failure.”

### EXAMPLE 1

### Preparation of Poly Epoxy Ester Resin Comprising UNOXOL™ Diol DGE and 2,6-Naphthalenedicarboxylic Acid

A mixture of 20.0 g of 2,6-naphthalenedicarboxylic acid, 26.2 g of UNOXOL™ Diol DGE, and 1.2 g of tetraphenylphosphonium bromide and 141.9 g of diethylene glycol dimethyl ether (diglyme) was agitated and heated to 135° C. in a 500 ml 3-neck flask with a condenser and nitrogen purge. After reaction at 135° C. for 2 hours, the mixture was further heated to 163° C. The polymerization was monitored by the titration of residual epoxy groups and acid groups. The reaction was stopped after 6 hours at 163° C. The polymer solution was precipitated into 750 ml of ice and methanol mixture within a blender. The polymer was collected, washed with methanol three times and dried a vacuum oven at 60° C. for 24 hours. The polymer product is a light-yellow clear solid. Its glass transition temperature is 51° C. and its weight average molecular weight is 23,200.

### EXAMPLE 2

### Preparation of Poly Epoxy Ester Resin Comprising UNOXOL™ Diol DGE and Isophthalic Acid

A mixture of 16.0 g of isophthalic acid, 27.2 g of UNOXOL™ Diol DGE, and 0.6 g of tetraphenylphosphonium bromide and 134.1 g of diethylene glycol dimethyl ether (diglyme) was stirred and heated to 135° C. in a 250 ml 3-neck flask with a condenser and nitrogen purge. The polymerization was monitored by the titration of residual epoxy groups and acid groups. The reaction was stopped after 2 hours at 135° C. The polymer solution was precipitated into 750 ml of ice and methanol mixture within a blender. The polymer was collected, washed with methanol three times and dried a vacuum oven at 60° C. for 24 hours. The polymer product is a light-yellow clear solid. Its glass transition temperature is 28° C. and its weight average molecular weight is 12,250.

### EXAMPLE 3

### Preparation of Poly Epoxy Ester Resin Comprising UNOXOL™ Diol DGE and Phthalic Acid

A mixture of 24.0 g of phthalic acid, 40.0 g of UNOXOL™ Diol DGE, 0.96 g of tetraphenylphosphonium bromide and 194.8 g of diethylene glycol dimethyl ether (diglyme) was stirred and heated to 135° C. in a 500 ml 3-neck flask with a condenser and nitrogen purge. The polymerization was monitored by the titration of residual epoxy groups and acid groups. The reaction was stopped after 1.5 hours at 135° C. The polymer solution was precipitated into 750 ml of ice and methanol mixture within a blender. The polymer was collected, washed with methanol three times and dried a vacuum oven at 60° C. for 24 hours. The polymer product is a light-yellow clear solid. Its glass transition temperature is 27.1° C. and its weight average molecular weight is 9,470.

### EXAMPLE 4

### Preparation of Poly Epoxy Ester Resin Comprising 1,4-CHDM DGE and 2,6-Naphthalenedicarboxylic Acid

A mixture of 15.0 g of phthalic acid, 19.2 g of 1,4-CHDM DGE (Epoxy Equivalent Weight (EEW)=128.2, purity by gas chromatography =99.0 area %), 0.51 g of tetraphenylphosphonium bromide and 104.1 g of diethylene glycol dimethyl ether (diglyme) was stirred and heated to 135° C. in a 250 ml 3-neck flask with a condenser and nitrogen purge. After reaction at 135° C. for 15 hours, the mixture was further heated to 163° C. The polymerization was monitored by the titration of residual epoxy groups and acid groups. The reaction was stopped after 4.4 hours at 163° C. The polymerization was monitored by the titration of residual epoxy groups and acid groups. The reaction was stopped after 1.5 hours at 135° C. The polymer solution was precipitated into 750 ml of ice and methanol mixture within a blender. The polymer was collected, washed with methanol three times and dried a vacuum oven at 60° C. for 24 hours. The polymer product is a light-yellow clear solid. Its glass transition temperature is 45.6° C. and its weight average molecular weight is 12160.

### Comparative Example A—Commercial Epoxy Resin

For comparison, a commercially available substantially linear high molecular weight epoxy resin, DER™ 669E, was measured by DSC and GPC for its Tg and molecular weight. The glass transition temperature of this bisphenol A based 9-type epoxy resin is 88.3° C. and its weight average molecular weight is 17450.

The results indicate that our new poly epoxy ester resins, Example 1-4, have similar weight average molecular weight as the bisphenol A based DER™ 669E, the commercially available high molecular weight epoxy resin.

The material flexibility and toughness were characterized by Stress-strain behavior under microtensile measurement according to ASTM D 1708. Elongation at break is a popular parameter to measure the flexibility of polymeric materials and tensile toughness is a measure of the ability of a material to absorb energy in a tensile deformation. The microtensile results of new high molecular weight poly epoxy ester resins are shown in Table I, in comparison with DER™ 669E, the bisphenol A based 9-type high molecular weight epoxy resin. The elongations to break of the new high molecular weigh poly epoxy ester resins in this invention are more than 100 times higher than DER™ 669E and their tensile toughness are over 100 times stronger than DER™ 669E. The data in Table I show that those new high molecular weigh poly epoxy ester resins in this invention are more much more flexible and tough than the 9-type bisphenol A based epoxy resin, although their weight average molecular weights are in a similar range.

TABLE I
Microtensile Results

| | Elongation to Break | tensile toughness |
|---|---|---|
| Sample # | (%) | (Mpa) |
| Example 1 | 79.6 | 6.65 |
| Example 2 | 360.9 | 7.97 |
| Example 3* | 3000 | 3.44 |
| Example 4 | 127.7 | 6.61 |
| Comparative | 0.67 | 0.03 |
| Example A: DER ™ 669E | | |

*elongation and tensile toughness of Example 3 were obtained at maximum lengths of our microtensile measurements, at which Example 3 did not break.

### EXAMPLE 5

### Coating of Poly Epoxy Ester Resin from Example 1

A mixture of 10.000 g of poly epoxy ester resin from Example 1, 1.111 g of phenolic crosslinker (Methylon 75108), 0.016 g of catalyst (85% phosphoric acid), 0.013 g of additive (BYK-310), 26.666 g of monobutyl ethylene glycol ether and 6.667 g of cyclohexanone was agitated for 16 hours forming a clear solution. The clear solution was filtered through a 1-micron syringe filter and then coated on tin free steel (TFS) panels with a # 20 draw down bar. The resultant panels with coatings were dried and cured in an oven at 205° C. for 15 minutes. The thickness of the cured coating is 5.4 micron.

### EXAMPLE 6

### Coating of Poly Epoxy Ester Resin from Example 4

A mixture of 10.000 g of poly epoxy ester resin from Example 4, 1.111 g of phenolic crosslinker (Methylon 75108), 0.016 g of catalyst (85% phosphoric acid), 0.013 g of additive (BYK-310) additive, 26.666 g of monobutyl ethylene glycol ether and 6.667 g of cyclohexanone was agitated for 16 hours forming a clear solution. The clear solution was filtered through a 1-micron syringe filter and then coated on tin free steel (TFS) panels with a # 20 draw down bar. The resultant panels with coatings were dried and cured in an oven at 205° C. for 15 minutes. The thickness of the cured coating is 4.3 micron.

Comparative Example B—Coating with DER™ 669E

A mixture of 10.000 g of DER™ 669E, 1.111 g of phenolic crosslinker (Methylon 75108), 0.016 g of catalyst (85% phosphoric acid), 0.013 g of additive (BYK-310), 26.666 g of monobutyl ethylene glycol ether and 6.667 g of cyclohexanone was agitated for 16 hours forming a clear solution. The clear solution was filtered through a 1-micron syringe filter and then coated on tin free steel (TFS) panels with a # 20 draw down bar. The resultant panels with coatings were dried and cured in an oven at 205° C. for 15 minutes. The thickness of the cured coating is 5.0 micron.

TABLE II
Coating Evaluation Results

| | Wedge Bend | |
|---|---|---|
| Coating # | (failure %) | MEK Double Rub |
| Example 5 | 0 | 100 |
| Example 6 | 0 | 100 |
| Comparative Example B | 25 | 75 |

All cured polymer coatings from Examples 5, 6 and Comparative Example B are based on similar coating formulations, except that different polymeric resins were used. All cured coatings are smooth and uniform without apparent defects. The flexibility of the cured coatings was evaluated by wedge bend measurement and the chemical resistance of the coatings was tested by MEK double rub tests. The results of the testing are shown in Table II. There was no any cracking and failure in the stressed coating surfaces from all coatings based on new high molecular weight poly epoxy ester resins in this invention, while the coatings based on 9-type high molecular weight DER™ 669E epoxy resin showed 25% failure along the length of the wedge bend. The wedge bend results indicate that the cured coatings based on new poly epoxy ester resins in this invention are more flexible than those coatings based on the bisphenol A based high molecular weight epoxy resin. In the mean time, the MEK double rub results illustrate that the cured coatings based on new poly epoxy ester resins in this invention provide similar or even better chemical solvent resistance, compared with the coatings from the bisphenol A based high molecular weight epoxy resin, DER™ 669E.

1. A poly epoxy ester resin composition comprising the following chemical structure: 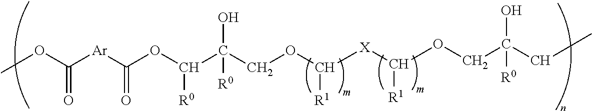
where n is a number from 2 to about 3000; each m independently has a value of 0 or 1; each R⁰ is independently —H or —CH₃; each R¹ is independently —H or a C₁ to C₆ alkylene radical (saturated divalent aliphatic hydrocarbon radical), Ar is a divalent aryl group or heteroarylene group; and X is a cycloaliphatic substructure wherein the section of the structure denoted by 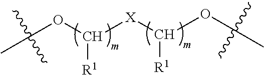
is selected from the group consisting of a cyclohexanedialkanol, a cyclohexenedialkanol, a cyclohexanolmonoalkanol, a cyclohexenolmonoalkanol, a decahydronaphthalenedialkanol, an octahydronaphthalenedialkanol, a 1,2,3,4-tetrahydronaphthalenedialkanol, a bicyclohexanedialkanol, a bicyclohexanemonoalkanol, norbornanedimethanol, bicyclooctanedimethanol, dicyclopentadienediol, a blend of a bridged cyclohexanol and said cycloaliphatic substructure, a blend of an alkylene groups and said cycloaliphatic substructure and mixtures thereof.

2. The composition of claim 1, wherein the advanced poly epoxy ester resin polymeric composition comprises a reaction product of (a) at least one cycloaliphatic diglycidyl ether compound, and (b) at least one aromatic dicarboxylic acid compound.

3. The composition of claim 2, wherein the at least one cycloaliphatic diglycidyl ether compound comprises a diglycidyl ether of cyclohexanedimethanol.

4. The composition of claim 2, wherein the at least one cycloaliphatic diglycidyl ether compound comprises a diglycidyl ether of cis-1,3-cyclohexanedimethanol and/or a diglycidyl ether of trans-1,3-cyclohexanedimethanol.

5. The composition of claim 2, wherein at least one cycloaliphatic diglycidyl ether compound comprises a diglycidyl ether of cis-1,4-cyclohexanedimethanol and/or a diglycidyl ether of trans-1,4-cyclohexanedimethanol.

6. The composition of claim 2, wherein the at least one cycloaliphatic diglycidyl ether compound comprises a diglycidyl ether of cis-1,3-cyclohexanedimethanol, a diglycidyl ether of trans-1,3-cyclohexanedimethanol, a diglycidyl ether of cis-1,4-cycloexanedimethanol, and/or a diglycidyl ether of trans-1,4-cyclohexanedimethanol.

7. The composition of claim 2, wherein the at least one cycloaliphatic diglycidyl ether compound comprises a diglycidyl ether of 1,1-cyclohexanedimethanol.

8. The composition of claim 2, wherein the at least one aromatic dicarboxylic acid compound comprises any aromatic compound with dicarboxylic acid structures and mixtures thereof.

9. The composition of claim 2, wherein the at least one aromatic dicarboxylic acid compound comprises a naphthalene dicarboxylic acid with the two —COOH group at any substitute positions, and mixtures thereof and the like.

10. The composition of claim 1, wherein the weight average molecular weight of the advanced poly epoxy ester resin polymeric composition is from about 300 to about 1,000,000.

11. The composition of claim 1, wherein the elongation to break at about 21° C. of the advanced poly epoxy ester resin polymeric composition is from about 5 percent to about 2000 percent as measured by the method ASTM D1708.

12. The composition of claim 1, wherein the tensile toughness at about 21° C. of the advanced poly epoxy ester resin polymeric composition is from about 0.05 MPa to about 500 MPa as measured by the method ASTM D1708.

13. The composition of claim 1, wherein the glass transition temperature of the advanced poly epoxy ester resin polymeric composition is from about −50° C. to about 200° C.

14. The composition of claim 1, wherein the advanced poly epoxy ester resin composition is made water-dispersible by (i) reacting the advanced poly epoxy ester resin polymeric composition with a water-dispersible acrylic; (ii) reacting the advanced poly epoxy ester resin polymeric composition with a water-dispersible polyester resin; (iii) grafting with at least one unsaturated acid monomer with a double bond which is polymerizable by free radical mechanism; (iv) grafting with at least one acid monomer with a double bond which is polymerizable by free radical mechanism and a vinylic monomer not containing an acid group; or (iv) reacting the advanced poly epoxy ester resin polymeric composition with a phosphoric and water and with (v) at least partial neutralization with a base of the reaction product of (i) to (iv).

15. The composition of claim 1, wherein the advanced poly epoxy ester resin composition is made water-dispersible by incorporating a dicarboxylic acid with a double bond which is polymerizable by free radical mechanism into the backbone and grafting with at least one acid monomer with a double bond which is polymerizable by free radical mechanism and a vinylic monomer not containing an acid group and at least partial neutralizating with a base.

16. A curable poly epoxy ester resin composition comprising (a) the poly epoxy ester resin composition of claim 1; and (b) at least one curing agent.

17. A cured resin prepared from the curable poly epoxy ester resin composition of claim 16.

18. A process for preparing the poly epoxy ester resin composition of claim 1 comprising preparing an advanced poly epoxy ester resin polymeric composition by reacting (a) at least one cycloaliphatic diglycidyl ether compound, and (b) at least one aromatic dicarboxylic acid compound.
